(19) United States
(12) Patent Application Publication
(10) Pub. No.: US 2016/0344445 A1
(43) Pub. Date: Nov. 24, 2016

(54) COEFFICIENT DETERMINATION FOR DIGITAL SUBSCRIBER LINE VECTORING

(71) Applicant: QUALCOMM Incorporated, San Diego, CA (US)

(72) Inventor: Shailendra Kumar Singh, Fremont, CA (US)

(21) Appl. No.: 15/159,332

(22) Filed: May 19, 2016

Related U.S. Application Data
(60) Provisional application No. 62/165,392, filed on May 22, 2015.

(51) Int. Cl. H04B 3/32; H04M 3/00

(52) U.S. Cl. CPC H04B 3/32; H04M 3/007

(57) ABSTRACT

Methods, systems, and devices are described for wired communication. In one aspect, a method relates to an approach to determine a coefficient based at least in part on a weighted average of multiple estimates of a coefficient from known (e.g., stored) coefficients. The weighted average approach may improve coefficient determination. For example, a weighted average interpolation/extrapolation approach is used to determine vectoring coefficients from known vectoring coefficients in a vectored DSL system. Such an approach may provide a significant improvement in the SNR performance of the system, for example, as compared to coefficients obtained by linear interpolation. The weighted average may be of a linear interpolation, a forward extrapolation and a backward extrapolation of the particular coefficient being determined. As such, linear interpolation, forward extrapolation and backward extrapolation may be leveraged to improve accuracy of the determined coefficient.

The present Application for Patent claims priority to U.S. Provisional Patent Application No. 62/165,392 by Singh, entitled “Method for Coefficient Interpolation,” filed May 22, 2015, assigned to the assignee hereof, and expressly incorporated by reference herein.

### BACKGROUND

Field of the Disclosure

The present invention relates generally to digital subscriber line (DSL) vectoring systems, and more particularly to methods and apparatuses to improve coefficient determination using a weighted average.

Description of Related Art

In a DSL system (e.g., asymmetric DSL (ADSL), high-bit-rate DSL (HDSL), very-high-bit-rate DSL (VDSL or VHDSL), single-pair high-speed DSL (SHDSL), G.fast, etc.), interference or crosstalk between neighboring twisted pairs may limit performance. For example, the crosstalk from a neighboring pair creates noise for the signal in a given pair. As the presence of crosstalk noise for the given pair negatively affects the signal-to-noise ratio (SNR) and the achievable data rate over the given pair, such crosstalk can limit transmission data rates.

DSL vectoring may be employed to reduce crosstalk. For DSL vectoring, user signals are jointly processed at the central office (CO) device. For downstream (DS) vectoring, user transmission signals are jointly processed to pre-compensate the cross-talk and the pre-compensated (vectored) signals are transmitted. For upstream (US) vectoring, user received signals are jointly post-processed to cancel the cross-talk and generate the cross-talk free (vectored) signals. In an N user vectored DSL system, for each tone an N×N matrix of coefficients is used to perform the DS or US vectoring. Because the vectoring coefficients require a large amount of memory to store, in practice only a limited (e.g., smaller) number of coefficients are stored for a set of tones. Coefficients for other tones, outside of the set of tones, are determined from the stored coefficients using some kind of interpolation, such as linear interpolation along the tone (e.g., frequency axis). However, linear interpolation does not result in accurate coefficients if the coefficients are nonlinear across the tone (e.g., frequency axis). Especially if the coefficients are large, linear interpolation of the coefficients can significantly limit the SNR performance and achievable data rates of the vectored system because of poor performance of reducing (e.g., canceling) crosstalk by vectoring.

### SUMMARY

The present description discloses techniques for improving coefficient determination from a set of known (e.g., stored) coefficients, such as for DSL vectoring. The described techniques involve using a weighted average of multiple estimates of a coefficient. As described herein, the weighted average may be of a linear interpolation, a forward extrapolation and a backward extrapolation of the coefficient being determined. Thus, the described approach leverages linear interpolation, forward extrapolation and backward extrapolation to improve accuracy of the determined coefficient.

A method of vectoring a signal in a DSL system is described. The method includes: obtaining a set of reference vectoring coefficients corresponding to a first set of tones in the DSL system; determining a vectoring coefficient for a tone outside of the first set of tones based at least in part on the set of reference vectoring coefficients, wherein the vectoring coefficient is determined based at least in part on a weighted average of a linear interpolation of the vectoring coefficient, a forward extrapolation of the vectoring coefficient, and a backward extrapolation of the vectoring coefficient; and, performing vectoring using the determined vectoring coefficient for the tone.

A communications device is described. The communications device includes: a memory to store a set of reference vectoring coefficients corresponding to a first set of tones in a digital subscriber line system; a vectoring coefficient determiner to calculate a vectoring coefficient, for a tone outside of the first set of tones based at least in part on the set of reference vectoring coefficients, based at least in part on a weighted average of a linear interpolation of the vectoring coefficient, a forward extrapolation of the vectoring coefficient, and a backward extrapolation of the vectoring coefficient; and, a vectoring signal generator to generate a vectored signal using the calculated vectoring coefficient for the tone.

Another communications device includes: means for storing a set of reference vectoring coefficients corresponding to a first set of tones in a digital subscriber line system; means for determining a vectoring coefficient, for a tone outside of the first set of tones based at least in part on the set of reference vectoring coefficients, based at least in part on a weighted average of a linear interpolation of the vectoring coefficient, a forward extrapolation of the vectoring coefficient, and a backward extrapolation of the vectoring coefficient; and, means for generating a vectored signal using the calculated vectoring coefficient for the tone.

Another communications device includes: a processor and memory communicatively coupled to the processor. The memory includes computer-readable code that, when executed by the processor, causes the communications device to: obtain a set of reference vectoring coefficients corresponding to a first set of tones in a DSL system; determine a vectoring coefficient for a tone outside of the first set of tones based at least in part on the set of reference vectoring coefficients, wherein the vectoring coefficient is determined based at least in part on a weighted average of a linear interpolation of the vectoring coefficient, a forward extrapolation of the vectoring coefficient, and a backward extrapolation of the vectoring coefficient; and, perform vectoring using the determined vectoring coefficient for the tone.

Regarding the above-described method and wired communication devices, the vectoring coefficient for the tone can be determined by determining a second set of vectoring coefficients corresponding to a second set of tones outside the first set of reference tones. The second set of vectoring coefficients can be recursively determined using weighted averages, each vectoring coefficient of the second set of vectoring coefficients being based at least in part on a separate weighted average.

The set of reference vectoring coefficients and the determined vectoring coefficient for the tone can be specific to a victim-disturber pair. The vectoring coefficient can be determined by weighting the weighted average based at least in part on the victim-disturber pair.

Alternatively or additionally, weighting the weighted average can be based at least in part on a distance of the tone from a nearest tone in the first set of tones, a signal-to-noise ratio, and/or a nonlinerarity of a vectoring coefficient function associated with the first set of tones.

Further scope of the applicability of the described systems, methods, devices, or computer-readable media will become apparent from the following detailed description, claims, and drawings. The detailed description and specific examples are given by way of illustration only, and various changes and modifications within the scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a DSL system in which techniques for coefficient determination can be implemented in accordance with various aspects of the present disclosure;

FIG. 2 is a diagram illustrating an example of values determined using a weighted average in accordance with various aspects of the present disclosure;

FIG. 3 is a diagram illustrating an example of a flow for determining coefficients using a weighted average in accordance with various aspects of the present disclosure;

FIG. 4 is a diagram illustrating another example of a flow for determining coefficients using a weighted average in accordance with various aspects of the present disclosure;

FIGS. 5A and 5B show block diagrams of examples of devices that may implement a weighted average approach to determine coefficients for vectoring in accordance with various aspects of the present disclosure;

FIG. 6 shows a flow chart that illustrates an example of a method of vectoring for a downstream signal in a DSL system in accordance with various aspects of the present disclosure; and

FIG. 7 shows a flow chart that illustrates an example of a method of vectoring for an upstream signal in a DSL system in accordance with various aspects of the present disclosure.

### DETAILED DESCRIPTION

According to aspects of the present disclosure, a weighted average of multiple estimates of a coefficient is used to determine a coefficient from known (e.g., stored) coefficients. In the present disclosure, a weighted average interpolation/extrapolation approach is used to determine the unknown vectoring coefficients from the known (stored) vectoring coefficients in a vectored DSL system. As described herein, the weighted average may be of a linear interpolation, a forward extrapolation and a backward extrapolation of the particular coefficient being determined. However, it should be understood that the weighted average approach described herein may be applied to any number of coefficient estimates that are determined by more than one estimation technique. In the context of this disclosure, linear interpolation, forward extrapolation and backward extrapolation may be leveraged to improve accuracy of the determined coefficient. By employing weighted averaging, the determination of unknown coefficients from the known coefficients may be nonlinearly interpolated between the known coefficients.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, portions of the methods described may be performed in an order different from that described, and various steps may be added, omitted, or combined. Also, features described with respect to some examples may be combined in other examples.

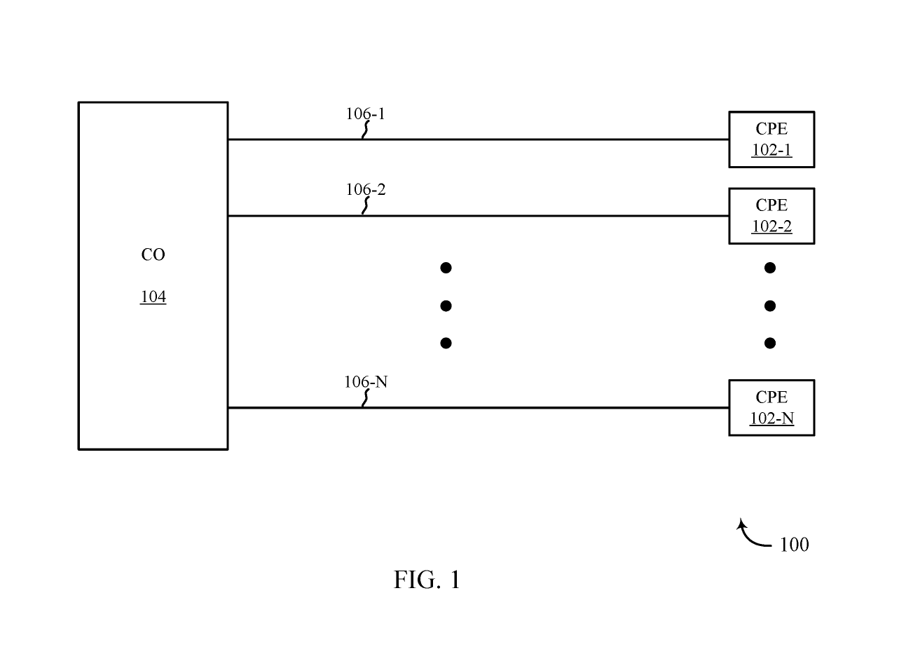

Referring first to FIG. 1, a block diagram illustrates an example of a DSL system 100 in which techniques for determining vectoring coefficients using a weighted average can be implemented in accordance with various aspects of the present disclosure. The DSL system 100 includes a plurality of N customer premise equipment (CPE) transceivers 102-1 to 102-N that are operatively coupled to a central office (CO) 104 via respective loops (e.g., twisted pairs) 106-1 to 106-N. The DSL system 100 can, for example, operate according to G.fast DSL technology, in which some or all of transceivers 102-1 to 102-N are configured as a vectoring group by CO 104.

The CPE transceivers 102-1 to 102-N of the DSL system 100 operating according to G.fast DSL are assigned certain frequency bands in which the CPE transceivers 102-1 to 102-N are permitted to transmit upstream signals according to a prescribed DSL system frequency band plan. Additionally, equipment in CO 104 such as a DSL access multiplexer (DSLAM) are assigned certain frequency bands in which the equipment in the CO 104 is permitted to transmit downstream signals according to the prescribed DSL system frequency band plan.

As discussed above, DSL vectoring can be used to reduce interference or crosstalk between neighboring twisted pairs, such as loops 106-1 to 106-N. In practice, a set of reference vectoring coefficients are known and the remaining unknown vectoring coefficients are determined using the reference vectoring coefficients. For example, the set of reference vectoring coefficients may be stored or otherwise obtained by the CO 104, which then determines the remaining vectoring coefficients and performs vectoring on signals transmitted over some or all of the loops 106-1 to 106-N to the respective CPE transceivers 102-1 to 102-N. Similarly, one or more of the CPE transceivers 102-1 to 102-N may employ vectoring for upstream transmissions.

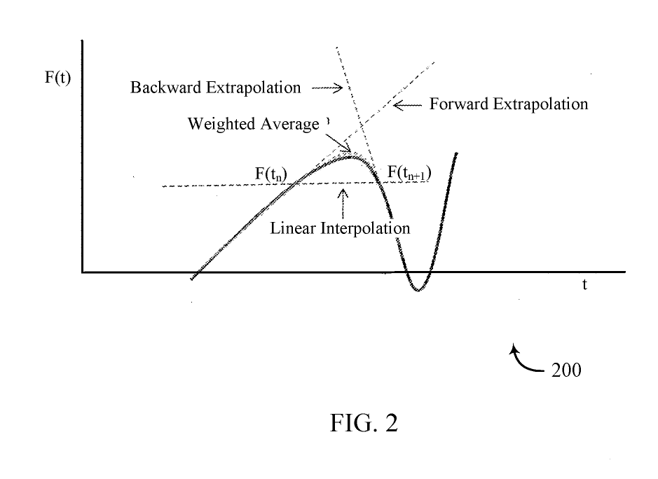

FIG. 2 is a diagram 200 illustrating an example of values determined using a weighted average in accordance with various aspects of the present disclosure. The diagram 200 illustrates coefficients as a function of tones, F(t), which in the context of the present disclosure corresponds to disturber coefficients of a victim for a set of tones to be used for DSL vectoring. In this example, the coefficients at points F(tₙ) and F(tₙ₊₁) are known (e.g., stored) reference vectoring coefficients corresponding to tones (e.g., for victim-disturber pairs) tₙ and tₙ₊₁, respectively. Vectoring coefficients at points (e.g., intermediate tones) between the points F(tₙ) and F(tₙ₊₁) are determined using the reference coefficients at points F(tₙ) and F(tₙ₊₁). Assuming dF(t₀)=0 and dF(t_{N})=0, the vectoring coefficient F(tₙ+i) at any tone tₙ+i<tₙ₊₁, 1≦n<N is estimated. The real and imaginary parts of the coefficients are interpolated along the tone axis and estimates are provided for both real and imaginary parts independently.

### Interpolation

Given the function F(·) available at discrete points t₁, t₂ . . . t_{N} with values F(t₁), F(t₂) . . . F(t_{N}). At any point tₙ<tₙ+i<tₙ₊₁ the value of the function F(tₙ+i) could be estimated using linear interpolation, such that the linear interpolated value is:

$$\hat{F} ( {t}_{n} + i ) = F ( {t}_{n} ) + i \frac{F ( {t}_{n + 1} ) - F ( {t}_{n} )}{{t}_{n + 1} - {t}_{n}} \qquad Eq . 1$$

Letting dF(n)=F(tₙ₊₁)−F(tₙ), and tₙ₊₁−tₙ=Δ(n), then:

$$\hat{F} ( {t}_{n} + i ) = F ( {t}_{n} ) + i \frac{dF ( n )}{Δ ( n )} \qquad Eq . 2$$

As shown by the dashed line of linear interpolated values in diagram 200, employing linear interpolation (e.g., a linear model) to determine the coefficients between the reference coefficients F(tₙ) and F(tₙ₊₁) does not accurately represent the function F(·) at the interpolated points when the function F(·) is not linear in that interval. When there is a change in slope at a point between the known (e.g., available) points, linear interpolation may not be able to accurately model the function F(·) at interpolated points. Thus, linear interpolation of coefficients between the reference coefficients F(tₙ) and F(tₙ₊₁) may result in relatively large estimation errors.

### Forward Extrapolation

Similarly, if F(tₙ₋₁) exists, where tₙ<tₙ+i<tₙ₊₁, the value F(tₙ+i) can be estimated using a forward extrapolation (linear in this example), such that the forward extrapolated value is:

$$\begin{matrix}{\hat{F}}_{f} ( {t}_{n} + i ) = F ( {t}_{n} ) + i \frac{F ( {t}_{n} ) - F ( {t}_{n - 1} )}{{t}_{n} - {t}_{n - 1}} \\ or & Eq . 3 \\ {\hat{F}}_{f} ( {t}_{n} + i ) = F ( {t}_{n} ) + i \frac{dF ( n - 1 )}{Δ ( n - 1 )} & Eq . 4\end{matrix}$$

If F(tₙ₋₁) does not exists, either assume Δ(n−1)=Δ(n) and dF(n−1)=dF(n) and compute \hat{F}_{f}(tₙ+i) as in Eq. 4 or assume dF(n−1)=0 and \hat{F}_{f}(tₙ+i)=F(tₙ).

As shown by the dashed line of forward extrapolated values in diagram 200, employing forward extrapolation to determine the coefficients between the reference coefficients F(tₙ) and F(tₙ₊₁) may not accurately represent the function F(·) at the interpolated points if a distance between the reference coefficient F(tₙ) and the coefficient being determined increases when the function F(·) is not linear in that interval. Hence, when there is a change in slope at a point between the known (e.g., available) points, forward extrapolation may not be able to accurately model the function F(·) at interpolated points farther from the known point used for extrapolation. Thus, forward extrapolation of coefficients between the reference coefficients F(tₙ) and F(tₙ₊₁) results in increasing estimation errors for coefficients away from the reference coefficient F(tₙ).

### Backward Extrapolation

Similarly, if F(tₙ₊₁) exist, at any point tₙ₊₁−j, the value F(tₙ₊₁−j) can be estimated using a backward extrapolation (linear in this example), such that the backward extrapolated value is:

$${\hat{F}}_{b} ( {t}_{n + 1} - j ) = F ( {t}_{n + 1} ) - j \frac{dF ( n + 1 )}{Δ ( n + 1 )} \qquad Eq . 5$$

Equivalently for any i=Δ(n)−j:

$${\hat{F}}_{b} ( {t}_{n} + i ) = F ( {t}_{n} ) + dF ( n ) - ( Δ ( n ) - i ) \frac{dF ( n + 1 )}{Δ ( n + 1 )} \qquad Eq . 6$$

For equally spaced t₁, t₂ . . . t_{N}, Δ(n)=Δ(n+1)=Δ, then:

$${\hat{F}}_{b} ( {t}_{n} + i ) = F ( {t}_{n} ) + dF ( n ) - dF ( n + 1 ) + i \frac{dF ( n + 1 )}{Δ} \qquad Eq . 7$$

Similarly, if F(tₙ₊₁) does not exists, either assume Δ(n+1)=Δ(n) and dF(n+1)=dF(n) and compute \hat{F}_{b}(tₙ+i) as in Eqs. 6 and 7 or assume dF(n+1)=0 and \hat{F}_{b}(tₙ+=F(tₙ).

As shown by the dashed line of backward extrapolated values in diagram 200, employing backward extrapolation to determine the coefficients between the reference coefficients F(tₙ) and F(tₙ₊₁) may not accurately represent the function F(·) at the interpolated points as a distance between the reference coefficient F(tₙ₊₁) and the coefficient being determined increases when the function F(·) is not linear in that interval. When there is a change in slope at a point between the known (e.g., available) points, backward extrapolation is not able to accurately model the function F(·) at interpolated points farther from the known point used for extrapolation. Thus, backward extrapolation of coefficients between the reference coefficients F(tₙ) and F(tₙ₊₁) results in increasing estimation errors for coefficients away from the reference coefficient F(tₙ₊₁).

Weighted Average Approach

If the slope of the function F(·) does not change too frequently (e.g., does not change more than once in two consecutive intervals of the known points), the effect of change in slope (e.g., nonlinearlity) of F(·) can be taken into account for determining the coefficient(s) F(tₙ+i) by taking weighted averages of the linearly interpolated value \hat{F}(tₙ+i), the forward extrapolated value \hat{F}_{f}(tₙ+i), and the backward extrapolated value \hat{F}_{b} (tₙ+i) When there are M points between tₙ and tₙ₊₁ where values of the function are to be determined, for i=1, . . . M let

$${w}_{i} = [ \begin{matrix}{w}_{i} ( 1 ) \\ {w}_{i} ( 2 ) \\ {w}_{i} ( 3 )\end{matrix} ] ,$$

and wᵢ(1)+wᵢ(2)+wᵢ(3)=1 To determine a value at tₙ+i, point \hat{F}ₐ (tₙ+i):

\hat{F}ₐ(tₙ+i)=wᵢ(1)\hat{F}_{f}(tₙ+i)+wᵢ(2)\hat{F}(tₙ+i)+wᵢ(3)\hat{F}_{b}(tₙ+i) Eq. 8

For equally spaced t₁, t₂ t_{N}, Δ(n−1)=Δ(n)=Δ(n+1)=Δ, then:

$${\hat{F}}_{a} ( {t}_{n} + i ) = F ( {t}_{n} ) + ( {w}_{i} ( 1 ) \frac{dF ( n - 1 )}{Δ} + {w}_{i} ( 2 ) \frac{dF ( n )}{Δ} + {w}_{i} ( 3 ) \frac{dF ( n + 1 )}{Δ} ) i + {w}_{i} ( 3 ) ( dF ( n ) - dF ( n + 1 ) ) \qquad Eq . 9$$

As shown by the dashed line of weighted average values in diagram 200, employing a weighted average of the linear interpolated value, the forward extrapolated value, and the backward extrapolated value for the respective coefficients between the reference coefficients F(tₙ) and F(tₙ₊₁) more accurately represents the function F(·) at the interpolated points than the three methods in isolation when the function F(·) is not linear in that interval. Thus, when there is a change in slope at a point between the known (e.g., available) points, a weighted average approach is able to more accurately model the function F(·) at interpolated points than linear interpolated, forward extrapolated, and backward extrapolated methods alone and results in smaller estimation errors.

As described above, the weighted average approach may provide distinct advantages over the linear interpolation approach conventionally used for determining vectoring coefficients. In addition to improving accuracy, the weighted approach is of relatively low complexity and has relatively low computational cost, such that the determination of vectoring coefficient can be performed in real time or near real time. The weighted average approach can be implemented to provide a smooth transition of slope, and is flexible in terms of estimation (e.g., interpolation, extrapolation, etc.) intervals.

Further, the weights employed may be selected (e.g., tuned) to model the nonlinearity of the function F(·), to achieve a desirable SNR (e.g., a highest SNR or best reduction of crosstalk), and/or based at least in part on the signals (e.g., victim-disturber pair and set of tones) for which the determined vectoring coefficients are employed (e.g., different weights for each set of coefficients). For each i=1, 2, . . . , M, the averaging weights used satisfy the conditions, 0≦wᵢ(k)≦1, for k=1, 2, 3 and wᵢ(1)+wᵢ(2)+wᵢ(3)=1. Different set of weights can be used for each victim-disturber pair and set of tones.

When forward extrapolation and rearward extrapolation are used for the weighted average approach, the respective weights can be inversely proportional to a distance of the point for the coefficient being estimated and a known point (e.g., tone of reference coefficient) being used for the extrapolation; for example,

$${w}_{i} ( 1 ) ∝ \frac{1}{i} , {w}_{i} ( 3 ) ∝ \frac{1}{M + 1 - i} and {w}_{i} ( 2 ) = 1 - {w}_{i} ( 1 ) - {w}_{i} ( 3 ) and$$

$$0 \leq {w}_{i} ( k ) \leq 1 for k = 1 \text{,} 2 \text{,} 3.$$

For the part of the tones where the linear interpolation meets the target SNR and weighted average (nonlinear) interpolation is not desired, the averaging weights are set to wᵢ(1)=0, wᵢ(2)=1 and wᵢ(3)=0. Further, for a lower complexity implementation, one or more weights can be set to zeros.

Further, the averaging weights can be selected for a relatively low complexity implementation of the multiplication. For example, the multiplication by two could be implemented as a binary left-shift by one and multiplication by three could be implemented as binary left-shift by one and add operations.

### Example 1

### 4-Tone Estimation (Δ=4)

Given a DSL vectoring system with 2048 tones and vectoring coefficients being available at equally spaced tones t₁, t₂ . . . t_{N} such that tₙ−tₙ₋₁=Δ=4, M=3 for every interval of tones (tₙ, tₙ₊₁). Intermediate coefficients are determined for every victim-disturber pair.

For the weighted average, the averaging weights w₁, w₂, w₃ (e.g., in this case same for all victim-disturber pairs and frequency band) are:

$${w}_{1} = \frac{1}{16} [ \begin{matrix}3 \\ 12 \\ 1\end{matrix} ] , {w}_{2} = \frac{1}{16} [ \begin{matrix}2 \\ 12 \\ 2\end{matrix} ] , {w}_{3} = \frac{1}{16} [ \begin{matrix}1 \\ 12 \\ 3\end{matrix} ] \qquad Eq . 10$$

### Example 2

### 2-Tone Estimation (Δ=2)

Given a DSL vectoring system with 2048 tones and vectoring coefficients being available at equally spaced tones t₁, t₂ . . . t_{N} such that tₙ−tₙ₋₁=Δ=2, M=1 for every interval of tones (tₙ, tₙ₊₁). Intermediate coefficients are determined for every victim-disturber pair.

For the weighted average, the averaging weights (e.g., in this case same for all victim-disturber and frequency band) are:

$${w}_{1} = \frac{1}{16} [ \begin{matrix}2 \\ 12 \\ 2\end{matrix} ] \qquad Eq . 11$$

In each of the foregoing examples, the weighted average approach provides significant SNR improvement as compared to the conventional linear interpolation approach.

For larger numbers of intermediate coefficients to be determined from a pair of adjacent reference points, the weighted average approach can be implemented recursively. For example, for an 8-tone estimation (Δ=8), first an intermediate midpoint is estimated via a 2-tone estimation. Then, two 4-tone estimations are performed, each using the intermediate midpoint (as a new reference point) and a respective one of the original pair of reference points. Alternatively, a 4-tone estimation is performed first, followed by three 2-tone estimations using adjacent points determined form the 4-tone estimation.

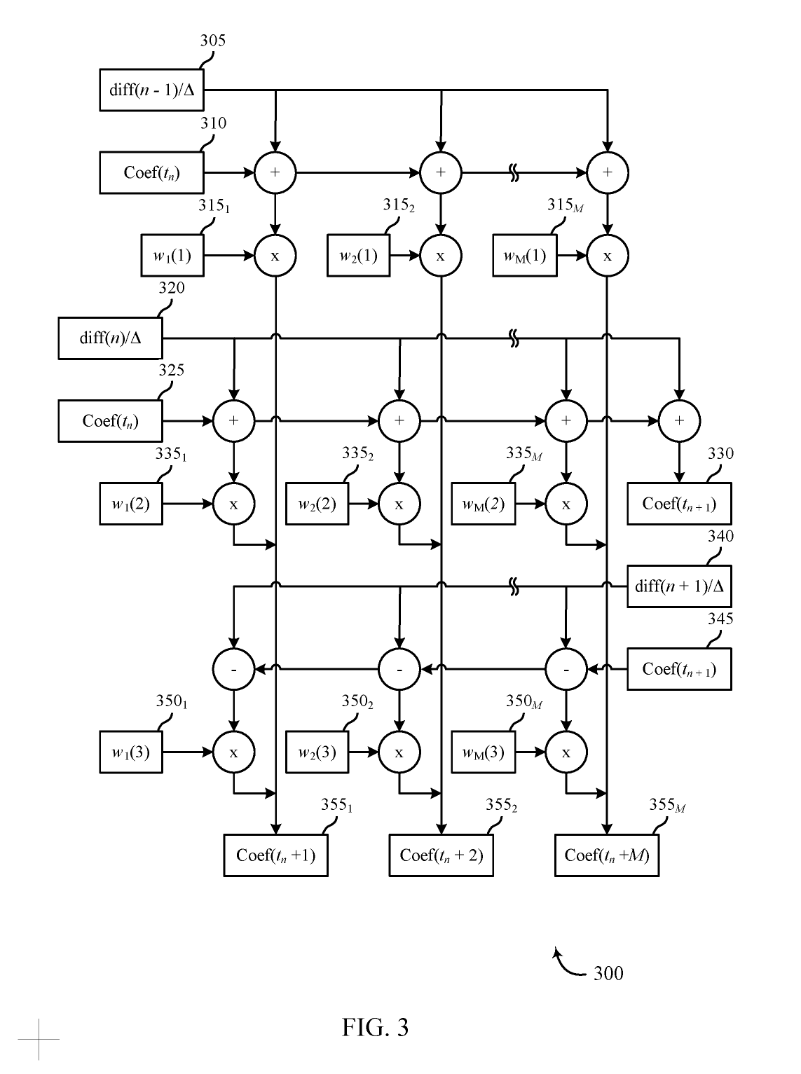

FIG. 3 is a diagram illustrating an example of a flow 300 for determining coefficients using a weighted average in accordance with various aspects of the present disclosure. The flow 300 can be implemented as dedicated hardware or a combination of general-purpose hardware and special-purpose software. The flow 300 includes calculating forward extrapolation estimates for coefficients i=1 to M obtained from blocks 305 and 310 (summing the coefficient value at tₙ with the quotient diff(n−1)/Δ, with equally spaced points, from Eq. 4). The calculated forward extrapolation estimates are then respectively weighted by blocks 315₁, 315₂ . . . 315_{M} (multiplying the estimates by the corresponding weights).

The flow 300 also includes calculating linear interpolation estimates for coefficients=1 to M obtained from blocks 320 and 325 (summing the coefficient value at tₙ with the quotient diff(n)/A, with equally spaced points, from Eq. 2). The calculated linear interpolation estimates are then respectively weighted by blocks 335₁, 335₂ . . . 335_{M} (multiplying the estimates by the corresponding weights).

After calculating the coefficient value at tₙ₋₁ (block 330) from blocks 320 and 325, the flow 300 continues with calculating backward interpolation estimates for coefficients i=1 to M obtained from blocks 340 and 345 (subtracting the coefficient value at tₙ₋₁ from the quotient diff(n+1)/Δ, with equally spaced points, from Eq. 7). The calculated backward extrapolation estimates are then respectively weighted by blocks 350₁, 350₂ . . . 350_{M} (multiplying the estimates by the corresponding weights).

The flow 300 calculates an average of the weighted estimates for each coefficient to determine the coefficients i=1 to M, as shown by blocks 355₁, 355₂ . . . 355_{M}.

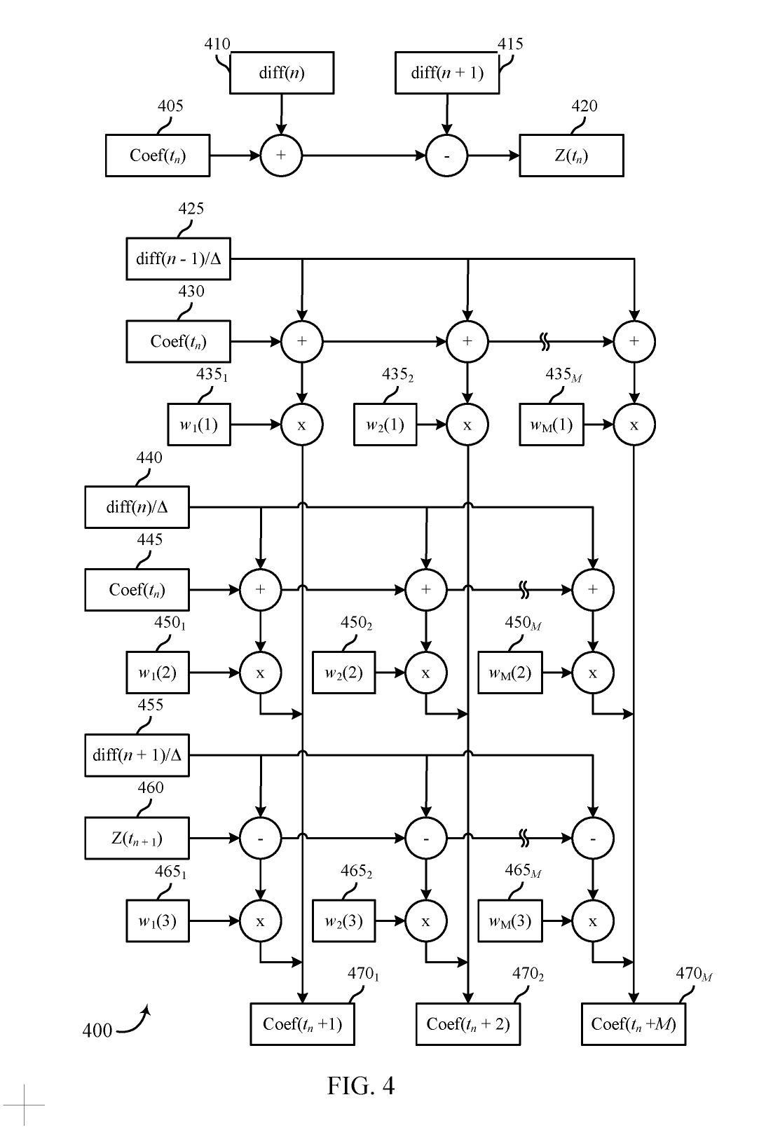

FIG. 4 is a diagram illustrating another example of a flow 400 for determining coefficients using a weighted average in accordance with various aspects of the present disclosure. The flow 400 can be implemented as dedicated hardware or a combination of general-purpose hardware and special-purpose software. Similar to the flow 300, the flow 400 includes calculating forward extrapolation estimates (from blocks 425 and 430) and linear interpolation estimates (from blocks 440 and 445) for coefficients i=1 to M. The calculated forward extrapolation estimates are respectively weighted by blocks 435₁, 435₂ . . . 435_{M} (multiplying the estimates by the corresponding weights). The calculated liner interpolation estimates are respectively weighted by blocks 450₁, 450₂ . . . 450 (multiplying the estimates by the corresponding weights).

However, for calculating backward extrapolation estimates, the flow 400 first determines a value Z(tₙ) (block 420) corresponding to the coefficient value at tₙ₋₁ from the coefficient value at tₙ (block 405), by adding diff(n) (block 410) and subtracting diff(n+1) (block 415). Doing so allows the determination of backward interpolation estimates for coefficients i=1 to M from blocks 455 and 460 (subtracting Z(tₙ) from the quotient diff(n+1)/Δ). The calculated backward extrapolation estimates are then respectively weighted by blocks 465₁, 465₂ . . . 465_{M} (multiplying the estimates by the corresponding weights).

The flow 400 calculates an average of the weighted estimates for each coefficient to determine the coefficients i=1 to M, as shown by blocks 470₁, 470₂ . . . 470_{M}.

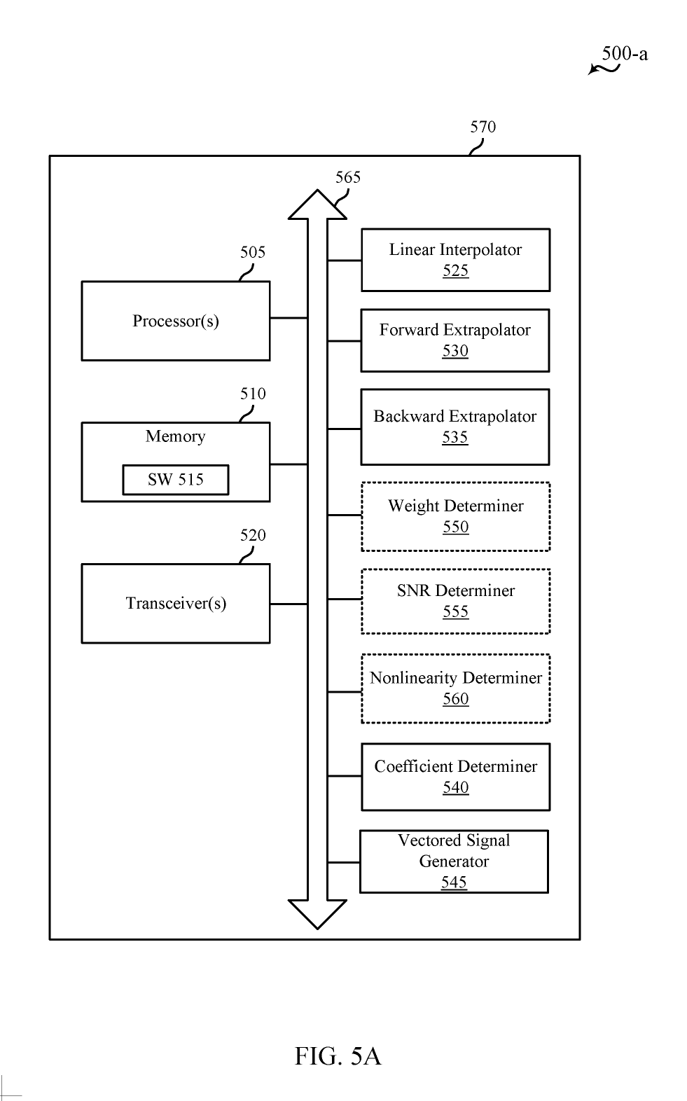

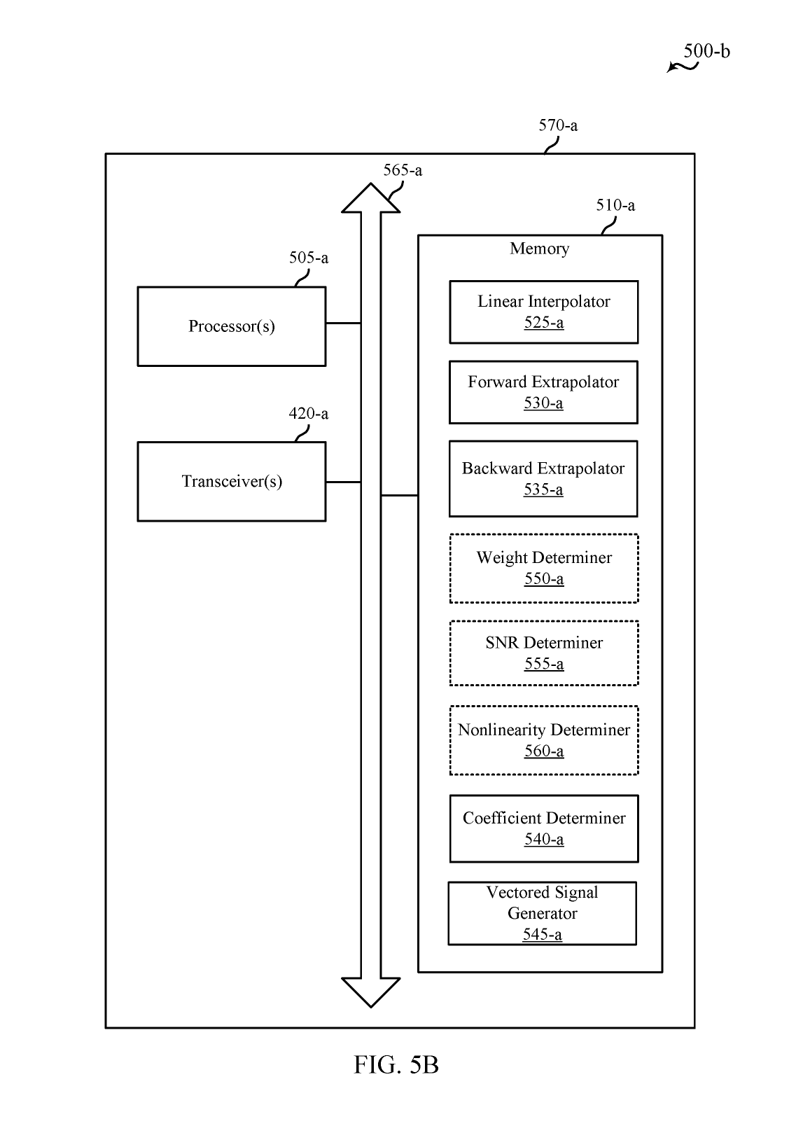

FIG. 5A shows a block diagram 500-a of an example of a device 570 that may implement a weighted average approach to determine coefficients for vectoring in accordance with various aspects of the present disclosure. The device 570 includes at least one processor 505, a memory 510, one or more transceivers 520, a linear interpolator 525, a forward extrapolator 530, a backward extrapolator 535, a coefficient determiner 540, and a vectoring signal generator 545. The processor(s) 505, the memory 510, the transceiver(s) 520, the linear interpolator 525, the forward extrapolator 530, the backward extrapolator 535, the coefficient determiner 540, and the vectoring signal generator 545 are communicatively coupled with a bus 565, which enables communication between these components.

The processor(s) 505 is an intelligent hardware device, such as a central processing unit (CPU), a microcontroller, an application-specific integrated circuit (ASIC), etc. The memory 510 stores computer-readable, computer-executable software (SW) code 515 containing instructions that, when executed, cause the processor(s) 505 or another one of the components of the device 500-a to perform various functions described herein, for example, to obtain reference vectoring coefficients, determine other vectoring coefficients using a weighted average of multiple estimates obtained using the reference vectoring coefficients, and perform vectoring to reduce crosstalk.

The linear interpolator 525, the forward extrapolator 530, the backward extrapolator 535, the coefficient determiner 540, and the vectoring signal generator 545 implement the features described with reference to FIGS. 1 through 3, as further explained below. Further, the linear interpolator 525, the forward extrapolator 530, the backward extrapolator 535, and the coefficient determiner 540 may cooperate to implement either of the algorithms described with reference to FIGS. 3 and 4. In some examples, the device 500 includes an SNR determiner 555 and/or a nonlinearity determiner 560 that cooperate(s) with a weight determiner 550 to determine (e.g., tune) the weights as described above and further below.

Again, FIG. 5A shows only one possible implementation of a device executing the features described herein. While the components of FIG. 5A are shown as discrete hardware blocks (e.g., ASICs, field programmable gate arrays (FPGAs), semi-custom integrated circuits, etc.) for purposes of clarity, it will be understood that each of the components may also be implemented by multiple hardware blocks adapted to execute some or all of the applicable features in hardware. Alternatively, features of two or more of the components of FIG. 5A may be implemented by a single, consolidated hardware block. For example, a single transceiver 520 chip or the like may implement the processor 505, the linear interpolator 525, the forward extrapolator 530, the backward extrapolator 535, the coefficient determiner 545, and the vectoring signal generator 550 (as well as the weight determiner 550, the SNR determiner 555 and the nonlinearlity determiner 560, when included).

In still other examples, the features of each component may be implemented, in whole or in part, with instructions embodied in a memory, formatted to be executed by one or more general or application-specific processors. For example, FIG. 5B shows a block diagram 500-b of another example of a device 570-a in which the features of the linear interpolator 525-a, the forward extrapolator 530-a, the backward extrapolator 535-a, the weight determiner 540-a (optional), the SNR determiner 555-a (optional), the nonlinearity determiner 560-a (optional), the coefficient determiner 545-a, and the vectoring signal generator 550-a are implemented as computer-readable code stored in memory 510-a and executed by one or more processors 505-a. Other combinations of hardware/software may be used to perform the features of one or more of the components of FIGS. 5A and 5B.

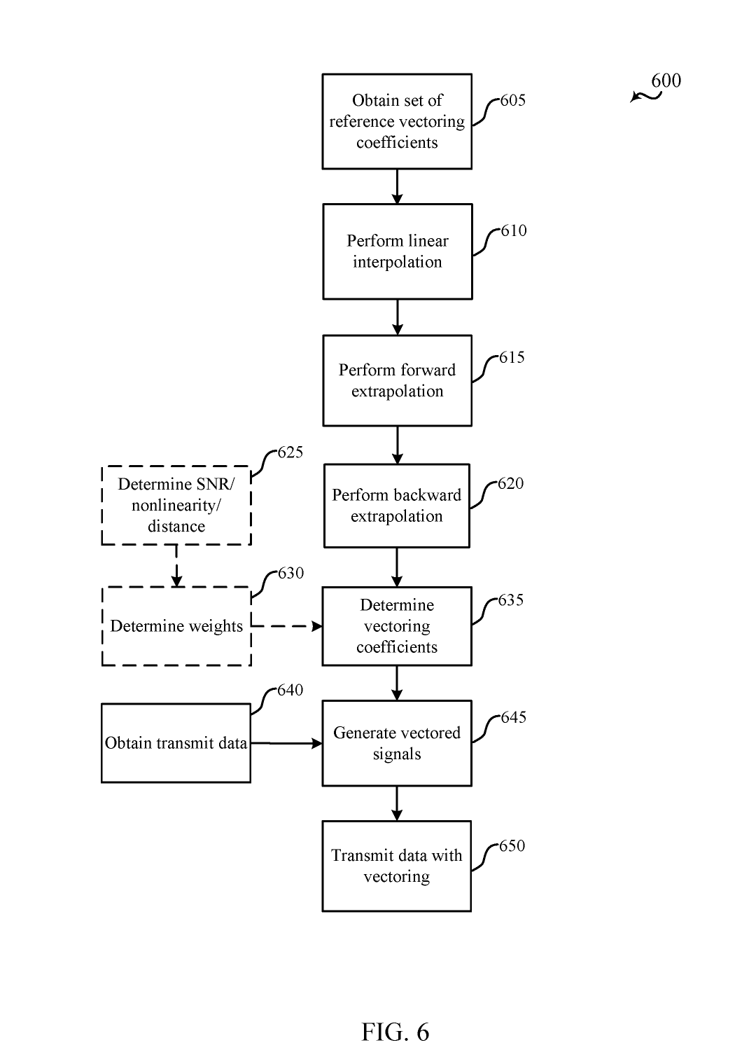

FIG. 6 shows a flow chart that illustrates an example of a method 600 of vectoring a downstream signal in a DSL system in accordance with various aspects of the present disclosure. The method 600 may be performed by any of the devices discussed in the present disclosure, but for clarity the method 600 will be described from the perspective of device 500-a of FIG. 5A. It is to be understood that the method 600 is just one example of techniques of improving vectoring coefficient determination in a DSL system, and the operations of the method 600 may be rearranged, performed by other devices and component thereof, and/or otherwise modified such that other implementations are possible.

Broadly speaking, the method 600 illustrates a procedure by which the device 500 determines vectoring coefficients and performs vectoring of a downstream signal (e.g., data) in a DSL system. The method 600 determines vectoring coefficients using a weighted average of several estimates for each vectoring coefficient, namely, a linear interpolation estimate, a forward extrapolation estimate, and a backward extrapolation estimate. The method 600 then generates a vectored signal using the known and determined vectoring coefficients to implement vectoring for transmitting data in the DSL system.

At block 605, the device 500 obtains a set of reference vectoring coefficients. In some cases, the reference vectoring coefficients are stored in the memory 510 and obtained by accessing the memory 510. In other cases, the reference vectoring coefficients are obtained from another device via the transceiver(s) 520. The set of reference vectoring coefficients are used to determine additional vectoring coefficients for vectoring in the DSL system.

At block 610, the linear interpolator 525 of the device 500 performs linear interpolation using the reference vectoring coefficients to determine linear interpolated values. At block 615, the forward extrapolator 530 of the device 500 performs forward extrapolation using the reference vectoring coefficients to determine forward extrapolated values. At block 620, the backward extrapolator 535 of the device 500 performs backward extrapolation using the reference vectoring coefficients to determine backward extrapolated values. While the operations at blocks 610, 615 and 620 are illustrated in series, it should be understood that such operations can be performed in a different order than shown or contemporaneously.

At block 635, the coefficient determiner 540 of the device 500 determines vectoring coefficients from a weighted average of respective linear interpolated values, forward extrapolated values and backward extrapolated values. In some cases, the weights for the weighted average are predetermined, for example, and stored in the memory 510 of the device 500. Alternatively, the weights are determined by the weight determiner 540 of the device 500, such as illustrated by optional blocks 625 and 630. At block 625, an SNR associated with a vectoring signal, a nonlinearity of the function defining the vectoring coefficients, and/or a distance between a respective point for a coefficient and the reference point used for estimation is/are determined by the respective component(s) 555, 560 and/or 505. Then, at block 630, the weight determiner 540 determines the weights to be applied to determine the weighted average of each vectoring coefficient.

At block 640, transmit data is obtained. It should be understood that the operation(s) at block 640 can be performed at any time prior to subsequent blocks with operations that depend on the transmit data. Once the vectoring coefficients are determined at block 635, the vectored signal generator 545 generates vectored signals, at block 645, using the known and the determined vectoring coefficients to vector the transmit data. Then, at block 650, the transceiver(s) 520 of the device 500 transmits data with vectoring according to the generated vectored signals.

It is to be appreciated that, in some cases, different vectored signals are generated for different victim-disturber pairs and set of tones. As such, the method 600 shown in FIG. 6 is for the sake of simplicity and illustration, and is not intended to be exhaustive of permutations that can be envisioned for practical implementations of DSL vectoring.

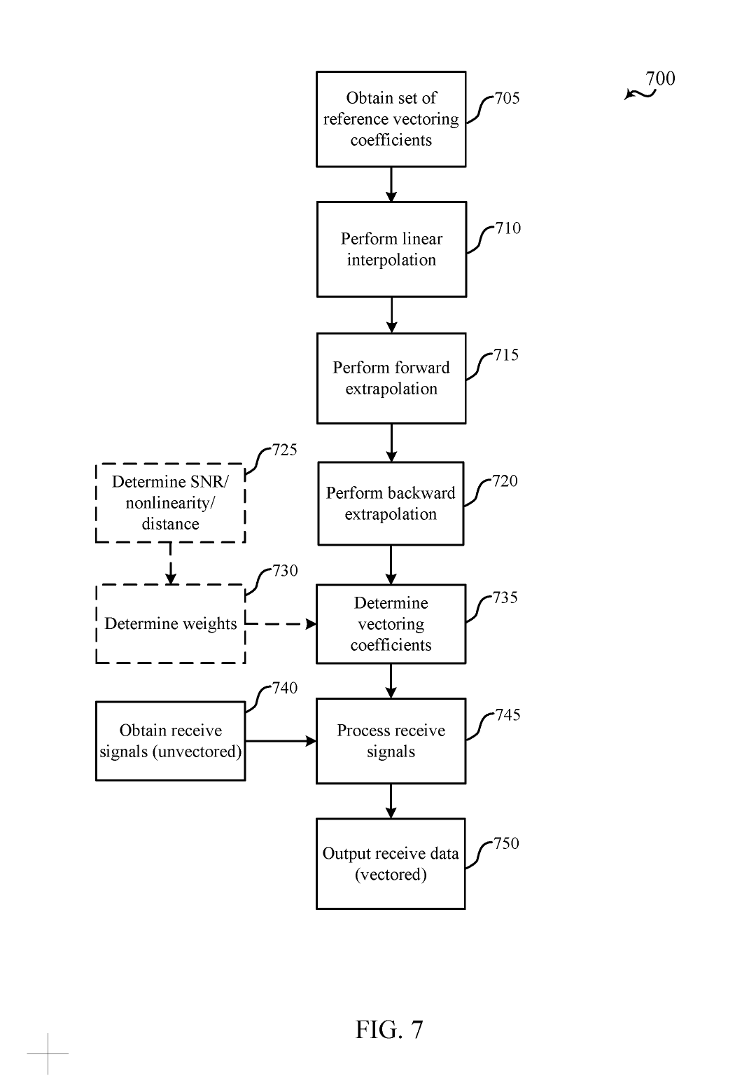

FIG. 7 shows a flow chart that illustrates an example of a method 700 of vectoring an upstream signal in a DSL system in accordance with various aspects of the present disclosure. The method 700 may be performed by any of the devices discussed in the present disclosure, but for clarity the method 700 will be described from the perspective of device 500-a of FIG. 5A. It is to be understood that the method 700 is just one example of techniques of improving vectoring coefficient determination in a DSL system, and the operations of the method 700 may be rearranged, performed by other devices and component thereof, and/or otherwise modified such that other implementations are possible.

Broadly speaking, the method 700 illustrates a procedure by which the device 500 determines vectoring coefficients and performs processing of an unvectored upstream signal in a DSL system. The method 700 determines vectoring coefficients using a weighted average of several estimates for each vectoring coefficient, namely, a linear interpolation estimate, a forward extrapolation estimate, and a backward extrapolation estimate. The method 700 then processes a receive signal (unvectored) using the known and determined vectoring coefficients to obtain the receive data (vectored).

As blocks 705 through 735 of FIG. 7 mirror blocks 605 through 635 of FIG. 6, the description thereof is not repeated here for the sake of brevity.

At block 740, unvectored receive signals are obtained. It should be understood that the operation(s) at block 740 can be performed at any time prior to subsequent blocks with operations that depend on the vectored receive signals. Once the vectoring coefficients are determined at block 735, the receive signals are processed, at block 745, using the known and the determined vectoring coefficients to obtain receive data (vectored). Then, at block 750, the vectored receive data is output, for example, by the transceiver(s) 520 of the device 500.

It is to be appreciated that, in some cases, different vectored signals are received for different victim-disturber pairs and set of tones. As such, the method 700 shown in FIG. 7 is for the sake of simplicity and illustration, and is not intended to be exhaustive of permutations that can be envisioned for practical implementations of DSL vectoring.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these.

Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method of vectoring a signal in a digital subscriber line (DSL) system, comprising:
obtaining a set of reference vectoring coefficients corresponding to a first set of tones in the DSL system;
determining a vectoring coefficient for a tone outside of the first set of tones based at least in part on the set of reference vectoring coefficients, wherein the vectoring coefficient is determined based at least in part on a weighted average of a linear interpolation of the vectoring coefficient, a forward extrapolation of the vectoring coefficient, and a backward extrapolation of the vectoring coefficient; and
performing vectoring using the determined vectoring coefficient for the tone.

2. The method of claim 1, wherein determining the vectoring coefficient for the tone comprises:
determining a second set of vectoring coefficients corresponding to a second set of tones outside the first set of reference tones.

3. The method of claim 2, wherein determining the second set of vectoring coefficients comprises:
recursively determining the second set of vectoring coefficients using weighted averages, wherein each vectoring coefficient of the second set of vectoring coefficients is based at least in part on a separate weighted average.

4. The method of claim 1, wherein the set of reference vectoring coefficients and the determined vectoring coefficient for the tone are specific to a victim-disturber pair.

5. The method of claim 4, wherein determining the vectoring coefficient further comprises:
weighting the weighted average based at least in part on the victim-disturber pair.

6. The method of claim 1, wherein determining the vectoring coefficient further comprises:
weighting the weighted average based at least in part on a distance of the tone from a nearest tone in the first set of tones.

7. The method of claim 1, wherein determining the vectoring coefficient further comprises:
weighting the weighted average based at least in part on a signal-to-noise ratio.

8. The method of claim 1, wherein determining the vectoring coefficient further comprises:
weighting the weighted average based at least in part on a nonlinerarity of a vectoring coefficient function associated with the first set of tones.

9. A communications device, comprising:
a memory to store a set of reference vectoring coefficients corresponding to a first set of tones in a digital subscriber line system;
a vectoring coefficient determiner to calculate a vectoring coefficient, for a tone outside of the first set of tones based at least in part on the set of reference vectoring coefficients, based at least in part on a weighted average of a linear interpolation of the vectoring coefficient, a forward extrapolation of the vectoring coefficient, and a backward extrapolation of the vectoring coefficient; and
a vectoring signal generator to generate a vectored signal using the calculated vectoring coefficient for the tone.

10. The communications device of claim 9, wherein the vectoring coefficient determiner calculates the vectoring coefficient for the tone to determine a second set of vectoring coefficients corresponding to a second set of tones outside the first set of reference tones.

11. The communications device of claim 10, wherein the vectoring coefficient determiner determines the second set of vectoring coefficients by recursively determining the second set of vectoring coefficients using weighted averages, each vectoring coefficient of the second set of vectoring coefficients based at least in part on a separate weighted average.

12. The communications device of claim 9, wherein the set of reference vectoring coefficients and the determined vectoring coefficient for the tone are specific to a victim-disturber pair.

13. The communications device of claim 12, wherein the vectoring coefficient determiner weights the weighted average based at least in part on the victim-disturber pair.

14. The communications device of claim 9, wherein the vectoring coefficient determiner weights the weighted average based at least in part on a distance of the tone from a nearest tone in the first set of tones.

15. The communications device of claim 9, wherein the vectoring coefficient determiner weights the weighted average based at least in part on a signal-to-noise ratio.

16. The communications device of claim 9, wherein the vectoring coefficient determiner weights the weighted average based at least in part on a nonlinerarity of a vectoring coefficient function associated with the first set of tones.

17. A communications device, comprising:
means for storing a set of reference vectoring coefficients corresponding to a first set of tones in a digital subscriber line system;
means for determining a vectoring coefficient, for a tone outside of the first set of tones based at least in part on the set of reference vectoring coefficients, based at least in part on a weighted average of a linear interpolation of the vectoring coefficient, a forward extrapolation of the vectoring coefficient, and a backward extrapolation of the vectoring coefficient; and
means for generating a vectored signal using the calculated vectoring coefficient for the tone.

18. The communications device of claim 17, wherein the means for determining the vectoring coefficient comprises:
means for determining a second set of vectoring coefficients corresponding to a second set of tones outside the first set of reference tones.

19. The communications device of claim 18, wherein the means for determining the second set of vectoring coefficients is configured to recursively determine the second set of vectoring coefficients using weighted averages, each vectoring coefficient of the second set of vectoring coefficients based at least in part on a separate weighted average.

20. The communications device of claim 17, wherein the set of reference vectoring coefficients and the determined vectoring coefficient for the tone are specific to a victim-disturber pair.

21. The communications device of claim 20, wherein the means for determining the vectoring coefficient comprises:
means for weighting the weighted average based at least in part on the victim-disturber pair.

22. The communications device of claim 17, wherein the means for determining the vectoring coefficient comprises:
means for weighting the weighted average based at least in part on a distance of the tone from a nearest tone in the first set of tones.

23. The communications device of claim 17, wherein the means for determining the vectoring coefficient comprises:
means for weighting the weighted average based at least in part on a signal-to-noise ratio.

24. The communications device of claim 17, wherein the means for determining the vectoring coefficient comprises:
means for weighting the weighted average based at least in part on a nonlinerarity of a vectoring coefficient function associated with the first set of tones.

25. A communications device, comprising:
a processor and memory communicatively coupled to the processor, the memory comprising computer-readable code that, when executed by the processor, causes the communications device to:
obtain a set of reference vectoring coefficients corresponding to a first set of tones in a DSL system;
determine a vectoring coefficient for a tone outside of the first set of tones based at least in part on the set of reference vectoring coefficients, wherein the vectoring coefficient is determined based at least in part on a weighted average of a linear interpolation of the vectoring coefficient, a forward extrapolation of the vectoring coefficient, and a backward extrapolation of the vectoring coefficient; and
perform vectoring using the determined vectoring coefficient for the tone.

26. The communications device of claim 25, wherein the computer-readable code, when executed by the processor, causes the communications device to:
determining a second set of vectoring coefficients corresponding to a second set of tones outside the first set of reference tones.

27. The communications device of claim 26, wherein the computer-readable code, when executed by the processor, causes the communications device to:
recursively determining the second set of vectoring coefficients using weighted averages, wherein each vectoring coefficient of the second set of vectoring coefficients is based at least in part on a separate weighted average.

28. The communications device of claim 25, wherein the set of reference vectoring coefficients and the determined vectoring coefficient for the tone are specific to a victim-disturber pair.

29. The communications device of claim 28, wherein the computer-readable code, when executed by the processor, causes the communications device to:
weight the weighted average based at least in part on the victim-disturber pair.

30. The communications device of claim 25, wherein the computer-readable code, when executed by the processor, causes the communications device to:
weight the weighted average based at least in part on a factor, wherein the factor is from the group consisting of: a signal-to-noise ratio and a nonlinerarity of a vectoring coefficient function associated with the first set of tones.
